(19) United States
(12) Patent Application Publication
(10) Pub. No.: US 2023/0419282 A1
(43) Pub. Date: Dec. 28, 2023

(54) SYSTEM AND METHOD FOR ONLINE MARKETPLACE FOR EXCHANGING NIL DIGITAL ASSETS AND DONATIONS

(71) Applicant: Viva Equity, Ltd., Lubbock, TX (US)

(72) Inventors: Mark PIGG, Lubbock, TX (US); Jim Simpson, Lubbock, TX (US); Matt Palmer, Lubbock, TX (US); Shannon Himango, Lubbock, TX (US); Jack Richards, Lubbock, TX (US)

(21) Appl. No.: 17/850,948

(22) Filed: Jun. 27, 2022

(51) Int. Cl. G06Q 20/12; G06Q 30/0601

(52) U.S. Cl. CPC G06Q 20/123; G06Q 2220/00; G06Q 30/0621

(57) ABSTRACT

The present disclosure provides systems, methods, and computer-readable storage devices for supporting an online marketplace that facilitates the exchange of digital assets from student athletes for donations from other users. An online marketplace platform may be configured to maintain accounts for student athletes users and to enable donations to the student athlete users from other users. For example, the online marketplace platform may receive donation information from a first user that indicates a payment amount and a second user designated as a recipient. The online marketplace platform may retrieve the payment amount from a payment source corresponding to the first user and increment an account of the second user based on the payment amount. Based on successful retrieval, the online marketplace platform may send a digital asset, such as a non-fungible token (NFT), associated with the second user to the first user.

### TECHNICAL FIELD

The present application is generally related to the technical field of online marketplaces for exchanging digital assets and targeted payments, and more particularly, but not by way of limitation, to systems that support exchange of donations to user-selected student athletes and digital assets, such as non-fungible tokens (NFTs), using the student athletes' names, images, or likenesses.

### BACKGROUND

Advances in technology have improved consumer experience in the retail, food services, sporting, and entertainment industries. For example, online shopping and delivery is now ubiquitous for many consumers, and streaming media has increased the quantity of television, movie, and music content available to customers with an internet connection and a variety of devices. In the sports industry, technological advancements have increased the availability and quality of televised or recorded sporting events available to viewers, as well as being at least partially responsible for the explosive growth of sports-related opportunities such as fantasy sports and sports betting. For example, it is possible that a fan of a certain sports team may be able to watch a sporting event of their favorite team on a television while also monitoring a fantasy sports team that includes one or more players on their favorite team and making a bet on their favorite team using a mobile phone and various apps.

Although online sporting and sports entertainment technology have dramatically increased fans ability to participate in new sports-related experiences, some challenges still exist in making such participation user friendly. Additionally, new opportunities for fan engagement continue to emerge due to changes in technology, laws and regulations, sporting rules, and the like. One such change that has the potential to significantly increase fan as well as athlete participation is the ability for student athletes in the United States to receive payment for use of their name, image, or likeness (NIL) and still be eligible to participate in collegiate athletics. Although some large groups and corporations have begun to enter into contracts with student athletes, the interests of smaller businesses and fans have largely been unaddressed. For example, a fan of a particular student athlete or collegiate athletic team may not know if the player or team they support is interested in receiving payment for use of their NIL. Additionally, should a fan identify a player they wish to financially support who is interested in such an arrangement, the fan may have to contact the student athlete directly to negotiate a desired deal, which is time consuming, difficult, and potentially unsafe for the fan and the student athlete. Lack of transparency or security regarding transfer of funds or receipt of agreed upon goods or services may further reduce the likelihood of such transactions occurring.

### BRIEF SUMMARY

Aspects of the present disclosure provide systems, methods, devices, and computer-readable storage media that support an online marketplace that facilitates the exchange of digital assets from individuals, such as student athletes, for donations (e.g., targeted payments) from other users of the online marketplace. The online marketplace may connect fans of student athletes, sports or teams, or higher education institutions with student athletes in a secure and transparent way to enable the fans to financially support student athletes of their choice and to enable student athletes to monetize their name, image, or likeness (NIL) in accordance with any rules or regulations of collegiate athletics. To illustrate, an online marketplace platform may enable donors and individual (e.g., student athletes) to register as users and, once registered, users that wish to donate money may identify the recipients of their donation from one or more individuals that are registered as users. To comply with NIL rules and regulations, users who donate money to student athletes receive a digital asset that includes the NIL of the student athletes that are registered as individual users. For example, the online marketplace platform may generate a digital asset, such as a non-fungible token (NFT) (e.g., a static or dynamic NFT), based on digital content (e.g., images, video, audio, etc.) of the individual, and the online marketplace platform may send the digital asset (e.g., a link to a blockchain that stores the NFT, a copy of the NFT, or the like) such that the donor receives a valuable digital commodity for their donation. Generation of the digital asset is automated by the online marketplace platform, thus enabling individual (e.g., student athletes) to provide digital assets with their NIL in exchange for donations without requiring the individuals to meet with or interact with the donors or to provide the digital assets themselves. Various tiers of digital assets may be available for particular donation tiers to encourage fans to donate more than minimal donations, and the online marketplace platform may support an online scoreboard and other features to gamify the donation process, as further described herein.

In some implementations, the registration process with the online marketplace platform may provide security and transparency for donors. For example, the registration process for an individual (e.g., a student athlete) user may include verification of the user's name, verification of their membership with a sports team, verification of their enrollment with a higher education institution, or the like. By verifying the individual user's identity, donors may have confidence that their payment is provided to the selected individuals and not scammers or other nefarious entities. Additionally, the registration may include the individual authorizing the online marketplace platform to create and provide digital assets on the individual's behalf and to accept money, and in some implementations withhold fees, on the individual's behalf. After the initial registration process, the online marketplace platform may maintain a debit account or a digital wallet for the individual user, and the account or digital wallet may be incremented based on receipt of donations designated for the individual. In some implementations, the online marketplace platform may initiate issuance of a debit card to enable the individual user to access the funds stored in their debit account or digital wallet. The online marketplace platform may be configured to enable customization of a user profile by the individual user, such as adding quotes, images, or other content to the profile, and the online marketplace platform may be configured to generate a user indicia corresponding to the user profile to enable the individual user to share their profile with fans. For example, the online marketplace platform may generate a QR code, a bar code, or another form of indicia that provides a link to the user profile, and the individual user may include the user indicia in social media posts or other messages to their fans to provide a simple and easy way for the fans to be able to donate to the individual. In some implementations, the online marketplace platform may be configured to restrict access to the debit account or digital wallet until the individual user completes one or more criteria, such as completing financial literacy classes or presentations, scheduling an appointment with a financial advisor, selecting whether to authorize the online marketplace platform to perform withholding in accordance with tax laws, or the like.

The registration process for a donor user may include linking a bank account, a credit card, or the like to the online marketplace platform to enable efficient and non-intrusive retrieval of funds donated by the donor user. Once a donor user is registered, the donor user may donate to any other users of the online marketplace platform. For example, the donor may specify that a recipient of a donation is a particular individual user or a group of individuals (e.g., student athletes). To further illustrate, the online marketplace platform may be configured to provide recipient searching by name, by school, by sport, by position, or a combination thereof. For example, a fan of a particular university and a particular position on a basketball team may make a donation to student athlete users that are associated with the university and the position without having to identify each individual by name. The online marketplace platform may also support group donations. For example, the donor user may configure their donation as a group donation that identifies one or more other donor users to be included in the group, and the online marketplace platform may send invitations to the other users to join the group donation for a particular donation amount, and the digital assets may be provided to each donor user that joins the donation group. In some implementations, the online marketplace platform supports a variety of payment options for performing donations, such as a one-time payment, a percentage of an account balance, a percentage of a transaction, or a recurring transaction based donation. The payment options may be configured such that retrieval of the payment avoids unnecessary transfer fees. As a non-limiting example, a donor user may select to pay from a bank account and to round up to the nearest dollar each transaction during a certain time period or up to a certain amount. To avoid transfer fees associated with retrieving a small payment amount for each transaction, the online marketplace platform may be configured to monitor for transactions and to increment a payment counter based on the amount rounded up. When the payment counter satisfies a threshold, the online marketplace platform may send a request for funds to the bank account, such as using an Automated Clearinghouse (ACH) request. The threshold may be set to a value that balances the twin goals of avoiding excess transfer fees and ensuring the availability of donated funds.

According to one aspect, a method for providing an online marketplace that facilitates exchange of digital assets from student athletes for donations is described. The method includes receiving, at an online marketplace platform, donation information from a first user associated with the online marketplace platform. The donation information indicates a payment source, a payment amount, and a designation of a second user associated with the online marketplace platform as a recipient. The second user includes a student athlete. The method also includes retrieving, by the online marketplace platform, the payment amount from the payment source. The method includes increasing, by the online marketplace platform, an account value of an account corresponding to the second user by at least a portion of the payment amount. The method also includes generating, by the online marketplace platform, a digital asset that includes a name of the second user, an image of the second user, a likeness of the second user, or a combination thereof. The method further includes sending, by the online marketplace platform, the digital asset to the first user based on retrieval of the payment amount.

According to another aspect, a system for providing an online marketplace that facilitates exchange of digital assets from student athletes for donations is described. The system includes at least one memory storing instructions and one or more processors coupled to the at least one memory. The one or more processors are configured to execute the instructions to [LD1] cause the one or more processors to receive donation information from a first user associated with an online marketplace platform. The donation information indicates a payment source, a payment amount, and a designation of a second user associated with the online marketplace platform as a recipient. The second user includes a student athlete. The one or more processors are also configured to execute the instructions to cause the one or more processors to retrieve the payment amount from the payment source. The one or more processors are configured to execute the instructions to cause the one or more processors to increase an account value of an account corresponding to the second user by at least a portion of the payment amount. The one or more processors are also configured to execute the instructions to cause the one or more processors to generate a digital asset that includes a name of the second user, an image of the second user, a likeness of the second user, or a combination thereof. The one or more processors are further configured to execute the instructions to cause the one or more processors to send the digital asset to the first user based on retrieval of the payment amount.

According to another aspect, a computer program product is described that includes a computer-readable storage device, such as a non-transitory computer-readable storage medium, that includes instructions that, when executed by one or more processors, cause the one or more processors to perform operations for providing an online marketplace that facilitates exchange of digital assets from student athletes for donations. The operations include receiving donation information from a first user associated with an online marketplace platform. The donation information indicates a payment source, a payment amount, and a designation of a second user associated with the online marketplace platform as a recipient. The second user includes a student athlete. The operations also include retrieving the payment amount from the payment source. The operations include increasing an account value of an account corresponding to the second user by at least a portion of the payment amount. The operations also include generating a digital asset that includes a name of the second user, an image of the second user, a likeness of the second user, or a combination thereof. The operations further include sending the digital asset to the first user based on retrieval of the payment amount.

The foregoing has outlined rather broadly the features and technical advantages of the present disclosure in order that the detailed description that follows may be better understood. Additional features and advantages will be described hereinafter which form the subject of the claims of the present disclosure. It should be appreciated by those skilled in the art that the conception and specific implementations disclosed may be readily utilized as a basis for modifying or designing other structures for carrying out the same purposes of the present disclosure. It should also be realized by those skilled in the art that such equivalent constructions do not depart from the scope of the present disclosure as set forth in the appended claims. The novel features which are believed to be characteristic of the aspects of this disclosure, both as to the organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying figures, in which:

FIG. 1 is a block diagram of an example of a system for providing an online marketplace that facilitates exchange of digital assets from individuals for donations according to one or more aspects;

FIG. 2 depicts an example of a graphical user interface (GUI) that displays profile information for an individual user of the online marketplace of FIG. 1 according to one or more aspects;

FIG. 3 depicts another example of a GUI that displays donation information for donating to individual(s) using the online marketplace of FIG. 1 according to one or more aspects; and

FIG. 4 is a flow diagram of an example of a method for providing an online marketplace that facilitates exchange of digital assets from student athletes for donations according to one or more aspects.

Although the present disclosure and its advantages have been described in detail, it should be understood that various changes, substitutions and alterations can be made herein without departing from the scope of the disclosure as defined by the appended claims. Moreover, the scope of the present application is not intended to be limited to the particular aspects of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or steps.

### DETAILED DESCRIPTION

Inventive concepts of the present disclosure provide systems, methods, devices, and computer readable storage media that support an online marketplace that facilitates the exchange of digital assets, such as non-fungible tokens (NFTs), and donations (e.g., targeted payments) between student athletes and fans. The online marketplace may connect fans of student athletes, sports or teams, or higher education institutions with student athletes in a secure and transparent way to enable the fans to financially support student athletes, or other individuals, of their choice and to enable student athletes to monetize their name, image, or likeness (NIL) in accordance with any rules or regulations of collegiate athletics. To illustrate, an online marketplace platform maintain accounts for individual users, such as student athletes, that can be incremented based on donations from donor users. Responsive to receiving a donation for a particular individual user, the online marketplace platform may send a digital asset (e.g., a link to a blockchain that stores the NFT, a copy of the NFT, or the like) to the donor user that submitted the donation. Registration of individual users may provide security and transparency to donors regarding their donations actually reaching the individuals. Additionally, the online marketplace platform may support a variety of payment options, including periodic payments that, in some implementations, are accumulated to reduce excess transfer fees between the online marketplace platform and a payment source of the donor. The online marketplace platform may be configured to enable user configurable donations, such as group donations, donations to single individuals or groups of individuals, searching for users by sport, by team, by school, or by position, and the like, that provides an efficient and intuitive user experience for both donor users and individual (e.g., student athlete) users. Thus, aspects described herein leverage computer technology to involve fans in a new sports experience on an individual or small group (e.g., micro) scale, compared to the current NIL experience which is predominantly at the large commercial level.

Certain units described in this specification have been labeled as modules in order to more particularly emphasize their implementation independence. A module is “[a] self-contained hardware or software component that interacts with a larger system.” Alan Freedman, “The Computer Glossary” 268 (8th ed. 1998). A module may comprise a machine- or machines-executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions that may be organized as an object, procedure, or function. Nevertheless, the executables of an identified module need not be physically located together, but may comprise disparate instructions stored in different locations that, when joined logically together, comprise the module, and when executed by the processor, achieve the stated data transformation. A module of executable code may be a single instruction, or many instructions, and may even be distributed over several different code segments, among different programs, and/or across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present aspects. One skilled in the relevant art will recognize, however, that aspects of the disclosure may be practiced without one or more of the specific details, or with other methods, components, materials, and so forth. In other instances, well-known structures, materials, or operations are not shown or described in detail to avoid obscuring aspects of the disclosure.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed aspect, the term “substantially” may be substituted with “within [a percentage] of” what is specified, where the percentage includes 0.1, 1, or 5 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Similarly, the phrase “A, B, C, or a combination thereof” or “A, B, C, or any combination thereof” includes A alone, B alone, C alone, a combination of A and B, a combination of A and C, a combination of B and C, or a combination of A, B, and C.

The terms “comprise” (and any form of comprise, such as “comprises” and “comprising”), “have” (and any form of have, such as “has” and “having”), and “include” (and any form of include, such as “includes” and “including”). As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any implementations of any of the systems, methods, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where.”

Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

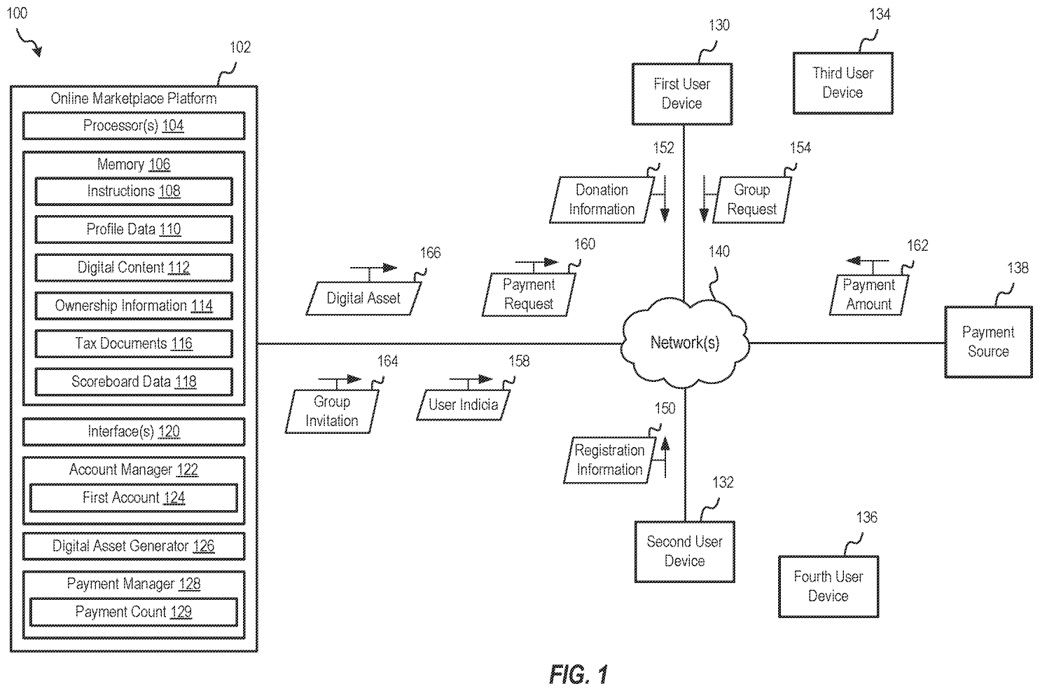

Referring to FIG. 1, a block diagram of an example of a system for providing an online marketplace that facilitates exchange of digital assets of individuals and donations between users according to one or more aspects is shown and designated 100. As shown in FIG. 1, the system 100 includes an online marketplace platform (referred to herein a “the platform 102”), multiple user devices including a first user device 130, a second user device 132, a third user device 134, and a fourth user device 136, a payment source 138, and one or more networks 140. In some implementations, one or more components of the system 100 may be optional, or the system 100 may include additional components, such as fewer than four or more than four user devices, additional payment sources, one or more client devices, cloud processing or cloud storage, or the like, as non-limiting examples.

The platform 102 may be configured to support an online marketplace for exchange of donations and digital assets between donor users and individual users, such as donors and student athletes, respectively. The platform 102, may include or correspond to a server, a desktop computing device, a laptop computing device, a personal computing device, a tablet computing device, a mobile device (e.g., a smart phone, a tablet, a personal digital assistant (PDA), a wearable device, and the like), a virtual reality (VR) device, an augmented reality (AR) device, an extended reality (XR) device, a vehicle (or a component thereof), an entertainment system, other computing devices, or a combination thereof, as non-limiting examples. The platform 102 includes one or more processors 104, a memory 106, one or more communication interfaces 120, an account manager 122, a digital asset generator 126, and a payment manager 128. In some other implementations, one or more of the components 122, 126, and 128 may be optional, one or more additional components may be included in the platform 102, or both. Additionally or alternatively, one or more of the account manager 122, the digital asset generator 126, and the payment manager 128 may include or correspond to one or more modules, such as dedicated hardware, circuitry, firmware, or the like, that is configured to perform the operations described with reference herein, or one or more of the account manager 122, the digital asset generator 126, and or the payment manager 128 may include or correspond to instructions (e.g., code, firmware, software, or a combination thereof) that is executed by the one or more processors 104 to perform the operations described herein. It is noted that functionalities described with reference to the platform 102 are provided for purposes of illustration, rather than by way of limitation and that the exemplary functionalities described herein may be provided via other types of computing resource deployments. For example, in some implementations, computing resources and functionality described in connection with the platform 102 may be provided in a distributed system using multiple servers or other computing devices, or in a cloud-based system using computing resources and functionality provided by a cloud-based environment that is accessible over a network, such as one of the one or more networks 140. To illustrate, one or more operations described herein with reference to the platform 102 may be performed by multiple servers or a cloud-based system that communicates with one or more client or user devices, one or more entity devices, or the like.

The one or more processors 104 may include one or more microcontrollers, application specific integrated circuits (ASICs), field programmable gate arrays (FPGAs), central processing units (CPUs) having one or more processing cores, or other circuitry and logic configured to facilitate the operations of the platform 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the platform 102 may be stored in the memory 106 as instructions 108 that, when executed by the one or more processors 104, cause the one or more processors 104 to perform the operations described herein with respect to the platform 102, as described in more detail below. Additionally, the memory 106 may be configured to store data and information, such as profile data 110, digital content 112, ownership information 114, tax documents 116, scoreboard data 118, or a combination thereof. Illustrative aspects of the profile data 110, the digital content 112, the ownership information 114, the tax documents 116, and the scoreboard data 118 are described in more detail below.

The one or more communication interfaces 120 may be configured to communicatively couple the platform 102 to the one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the platform 102 includes one or more input/output (I/O) devices that include one or more display devices, a keyboard, a stylus, one or more touchscreens, a mouse, a trackpad, a microphone, a camera, one or more speakers, haptic feedback devices, or other types of devices that enable a user to receive information from or provide information to the platform 102. In some implementations, the platform 102 is coupled to a display device, such as a monitor, a display (e.g., a liquid crystal display (LCD) or the like), a touch screen, a projector, a VR display, an AR display, an XR display, or the like. In some other implementations, the display device is included in or integrated in the platform 102. Alternatively, the platform 102 may not be connected to or include a display device, and displayable information generated by the platform 102 may be displayed at one or more user devices or client devices.

The account manager 122 is configured to manage one or more accounts, such as debit accounts or digital wallets, for one or more users of the online marketplace hosted by the platform 102. For example, the account manager 122 may host and manage a debit account or digital wallet for each individual user of the online marketplace that completes a registration process, including authorizing the platform 102 to accept funds and manage an account on the individual's behalf. The account manager 122 may operate similar to some online banking or credit account management systems or digital wallet management systems. In some implementations, the accounts (e.g., debit accounts, digital wallets, etc.) managed by the account manager 122 may each be linked to a corresponding debit card to enable the corresponding user to withdraw funds from the account. Additionally or alternatively, the accounts may be other types of accounts, such as savings accounts, checking accounts, or the like.

The digital asset generator 126 is configured to generate digital assets to be provided to donor users based on successful retrieval of payment from corresponding payment sources. For example, the digital asset generator 126 may be configured to generate digital assets that include or are based on the name, image, or license (NIL) of an individual user that receives a donation from a donor user. In this example, the digital asset that is generated is provided to the donor user to comply with NIL regulations for college athletics in the United States. In other implementations, the digital assets may be provided in accordance with other rules or regulations. Further, although examples described herein are in the context of student athletes being the individual users, in some other implementations, the details described herein may be implemented for other types of individual users, such as professional sports players, amateur sports players, artists, actors, musicians, authors, other types of individuals, or any combination thereof. In some implementations, the digital assets may be non-fungible tokens (e.g., NFTs). For example, for a particular individual user, the digital asset generated 126 may generate an NFT based on an image of the particular individual, such as by combining the image and ownership information of the donor user to receive the NFT as an entry to be added to a blockchain. By adding such an entry to the blockchain, the digital asset (e.g., the NFT) becomes immutable and the donor user's ownership is tied to the image, at least for the duration of the blockchain. Additionally, the digital asset generator 126 may be configured to provide a copy of the NFT to the donor user, such as via email, a link to download the copy of the NFT, a link to the blockchain that stores the NFT, or the like. The NFTs described herein may include static NFTs (e.g., NFTs based on static digital content), dynamic NFTs (e.g., NFTs based on dynamically modifiable digital content), or both. Although described in the context of an NFT, in other implementations, the digital asset may be any type of digital content or item that can be provided as value in exchange for donations from users of the online marketplace.

The payment manager 128 is configured to manage the payment indicated in donations from donor users. For example, the payment manager 128 may be configured to communicate with payment source(s) indicated by a submitted donation to retrieve the payment amount from the payment sources. In some implementations, the payment manager 128 is configured to support multiple types of payments, such as one-time payments, percentage of balance payments, percentage of transaction payments, periodic transaction-based payments, or a combination thereof, as further described herein. An example of a periodic transaction-based payment includes a payment that is derived by rounding up each payment or other transaction to a particular amount (e.g., a next dollar) during a time period, as further described herein. Additionally or alternatively, the payment manager 128 may be configured to collect a portion of the payment for fees associated with operating the online marketplace, which may be specified in the registration process for student athlete users, prior to providing a remainder of the received payment to the account manager 122. In some implementations, a student athlete user may select to have the platform 102 withhold a portion of payments to comply with tax rules or regulations, and the payment manager 128 may be configured to withhold a portion of received payments for submission to a tax collection agency prior to providing a remainder of the received payments to the account manager 122, as further described herein.

The user devices 130-136 are configured to communicate with the platform 102 to enable donation of money to individuals (e.g., student athletes) in return for digital assets or to enable interaction with an account (e.g., a digital wallet, a debit account, or other account) that stores donated funds on behalf of an individual. For example, the user devices 130-136 may be configured to execute an online marketplace application that enables the user devices 130-136 to communicate with the platform 102 via the networks 140 to participate in the online marketplace supported by the platform 102 (e.g., execution of the application may cause the user devices 130-136 to provide online marketplace functionality as further described herein). Additionally or alternatively, the user devices 130-136 may communicate and interact with platform 102 through the internet, such as through a website. The user devices 130-136 may include or correspond to a mobile device (e.g., a smart phone, a tablet, a PDA, a wearable device, and the like), a desktop computing device, a laptop computing device, a personal computing device, a tablet computing device, a server, a VR device, an AR device, an XR device, a vehicle (or a component thereof), an entertainment system, other computing or electronic devices, or a combination thereof, as non-limiting examples. The user devices 130-136 may be used by different types of users, such as individuals (e.g., student athletes) or donors. For example, the first user device 130 and the third user device 134 may be used by donor users, and the second user device 132 and the fourth user device 136 may be used by individual users. Although four user devices 130-136 are shown in FIG. 1, in some other implementations, more than four or fewer than four user devices may be included in the system 100.

The payment source 138 is configured to provide payment for donors to be managed by the platform 102. For example, the payment source 138 may include a server or other computing device of a bank or other financial institution, a credit card or credit provider, or the like, that is communicatively coupled to the platform 102 and one or more of the user devices 130-136 by the one or more networks 140. In the particular example shown in FIG. 1, the payment source 138 corresponds to a user of the first user device 130. Although shown as a single element, each user may specify one or more payment sources for making donations. The payment source 138 may be configured to transfer funds from an account of the corresponding user to the platform 102 upon request, either one time or multiple times. For example, the platform 102 may issue an Automated Clearinghouse (ACH) request to the payment source 138, such as a bank account, to receive a transfer of the requested amount of funds. In some implementations, the payment source 138 may permit the platform 102 to monitor transactions handled by the payment source 138 or otherwise provide transaction data such that the platform 102 can determine when to issue ACH requests, as further described herein.

During operation of the system 100, users may register with the online marketplace hosted by the platform 102. The online marketplace may be accessed via users and interested parties via an online marketplace application, via a webpage, or the like. Registration by the users enables creation of user profiles that are stored by the platform as the profile data 110 (e.g., data representing one or more donor users, one or more individual users, or a combination thereof). A registration process for donor users of the online marketplace, such as a first user of the first user device 130, may be relatively simple and may include providing a name and optionally other identifying information, a user profile name and password, and at least one payment source for donations. For example, the first user may link one or more payment sources, including the payment source 138, to their user profile. The payment source 138 may include or correspond to a bank account, a credit union account, a credit card, or another type of payment source. After completing the registration process for the first user, the platform 102 may create a user profile for the first user. The user profile may be accessed to view or edit user information, such as name, password, payment sources, or the like.

A registration process for individual users of the online marketplace, such as a second user of the second user device 132, may be more complicated than that of a donor user in order to provide the security and transparency to donors that their money is reaching the individuals they identify and not being given to others or taken by scammers. To perform the registration process, the second user device 132 may display a graphical user interface (GUI) that includes multiple questions and requests for information from the second user, and based on user input responding to the questions, the second user device 132 may generate and send registration information 150 to the platform 102. The registration information 150 may include information entered by the second user, such as identification information, a profile name and password, various authorizations, and the like. As a non-limiting example, the registration information 150 may include a name and optionally other identifying information, a name of a higher education institution in which the second user is enrolled, a sport played by the second user, and authorization by the second user for the platform 102 to receive donations (e.g., money, payment, funds, etc.) on behalf of the second user and to provide digital assets that incorporate the second user's name, image, or likeness. The authorization may also include authorization by the second user to deduct or withhold a portion of received donations as fees for services provided by the platform 102. The fees may be deducted on a periodic basis, a one-time basis, a per-donation basis such as a percentage of each donation, or the like.

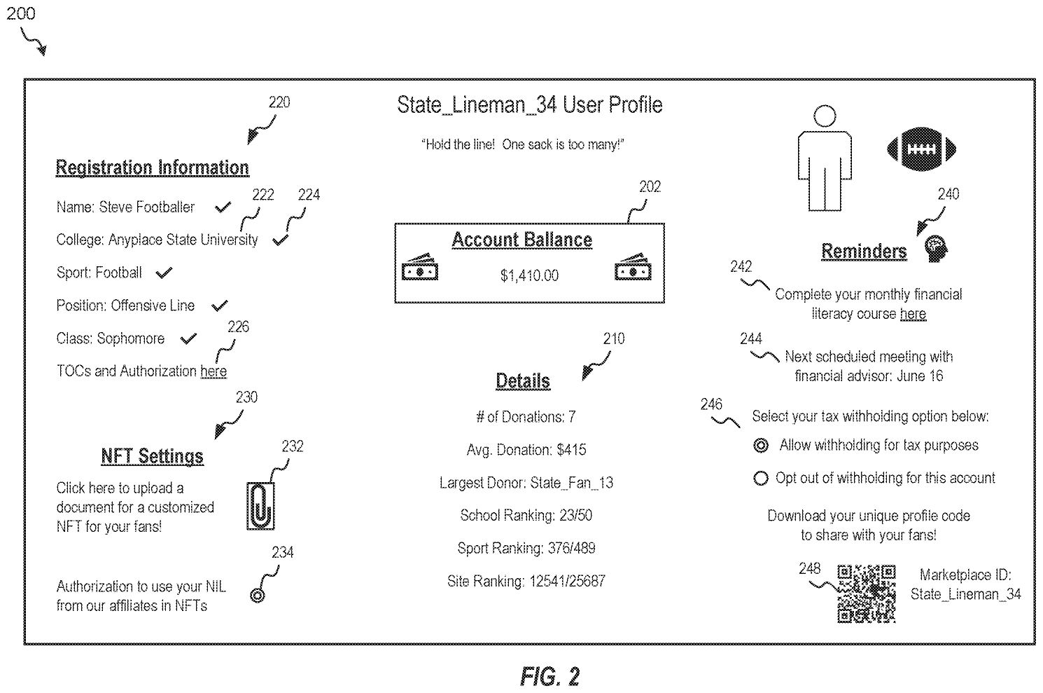

The platform 102 may receive the registration information 150 and perform one or more registration operations to register the second user as an individual user of the online marketplace. In some implementations, the registration operations include one or more verification operations. For example, the registration operations may include verifying an identity of the second user, verifying an enrollment of the second user with one or more educational institutions, verifying a sport participated in by the second user, verifying that the second user is a member of the sporting team of an educational institution, or a combination thereof. In some implementations, the platform 102 may perform verification operations, such as by contacted one or more identity databases, contacting one or more educational institutions, crawling or otherwise analyzing web pages, social media feeds, or the like, other types of verification operations, or a combination thereof. Alternatively, the platform 102 may contract with a third party verification service to perform the verification, and the verification may be succeed or fail based on information received from the third party verification service. In addition to verifying the second user and receiving authorization to receive money, deduct fees, and provide digital assets, the registration operations may also include providing the second user with an option to initiate withholding of money from their account for tax purposes. For example, the second user device 132 may present a selectable option to initiate tax withholding for funds of the second user, and based on selection of the selectable option, the platform 102 may provide one or more electronic tax documents to the second user and withhold a portion of funds from their account to be provided to a tax agency. Additional details of the optional withholding are further described herein with reference to FIG. 2. Upon completion of the registration operations, the platform 102 may create a user profile for the second user that can be accessed to change information, to view an account balance, to change options, or the like, as further described with reference to FIG. 2.

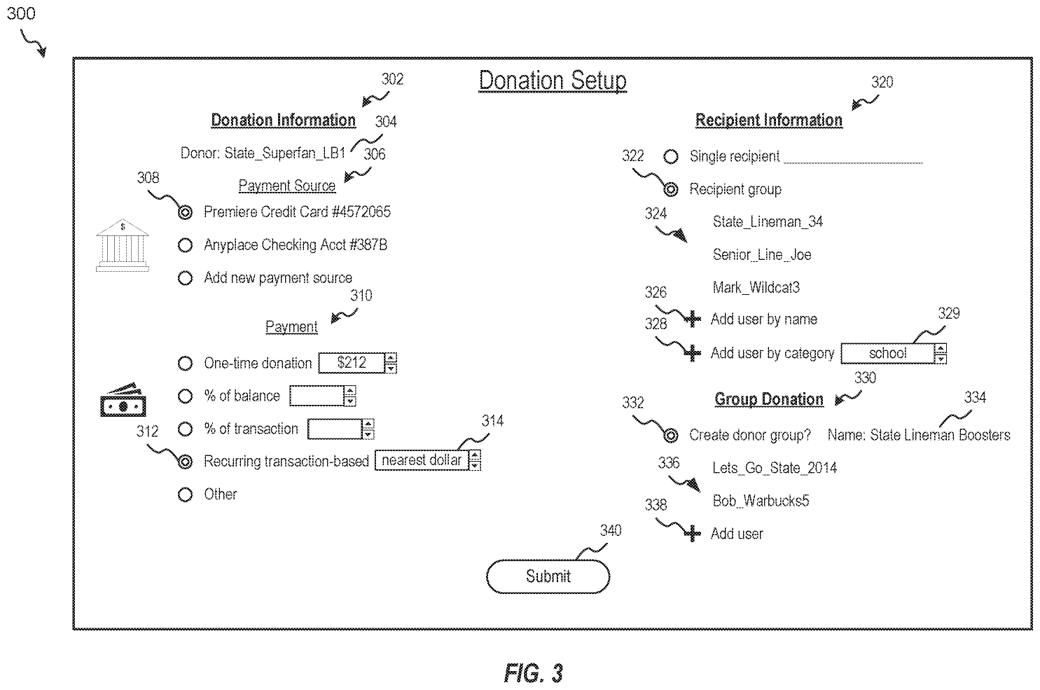

Once the users are registered with the online marketplace (e.g., the platform 102), donor users may make donations to individual (e.g., student athlete users), and individual users may receive donations into their accounts. For example, the first user may use the online marketplace application at the first user device 130 to make a donation to one or more individual. The first user device 130 may display a GUI that enables the first user to make a configurable donation to other individual user(s) of their choice. An example of such a GUI is described further herein with reference to FIG. 3. Responsive to the first user selecting various options for the donation, the first user device 130 may generate and send donation information 152 to the platform 102. The donation information 152 may indicate a corresponding payment source, a corresponding payment amount, and a designation of one or more individual users of the online marketplace as recipient(s) of the donation. In the example shown in FIG. 1, the donation information 152 may indicate the payment source 138 as the corresponding payment source for the donation and a payment amount 162 to be retrieved from the payment source 138 for paying the donation. In some implementations, donations may be designated for a single user. For example, the donation information 152 may indicate that the second user of the second user device 132 is designated as the recipient of the donation. Alternatively, the donation information 152 may indicate that the recipient of the donation is a user group that includes the second user of the second user device 132 and a fourth user of the fourth user device 136 (e.g., another individual user). The user group may include a custom grouping of individuals selected by the first user (e.g., multiple individually selected student athlete users) or may correspond to a particular team of a particular educational institution, such as the men's basketball team of a first university or the women's swimming team of a second university, or a particular grouping within a team, such as wide receivers of a football team or seniors of a softball team. Additional details of selecting a user group as recipient of a donation are described herein with reference to FIG. 3.

The platform 102 may receive the donation information 152 from the first user device 130 and the payment manager 128 may process the donation information 152 to facilitate transfer of money from the first user to the second user (or any other users indicated as recipients of the donation). Processing the donation information 152 may include identifying an amount indicated by the donation and a source from which payment is to be retrieved. To illustrate, based on the donation information 152, the payment manager 128 (e.g., the platform 102) may send a payment request 160 to the payment source 138 to retrieve a payment amount 162 indicated by the donation information 152. For example, based on receiving the payment request 160, the payment source 138 may send the payment amount 162 to the platform 102. In some implementations, the payment request 160 may include or correspond to an ACH request.

As described above, the payment source 138 may include or correspond to a credit card server, a bank server, or the like, and the payment amount 162 may be a one-time payment (e.g., a particular amount), a percentage of a balance, a percentage of one or more particular transactions, a recurring transaction-based amount (e.g., rounding up each transaction during a time period to the nearest dollar or another amount), or another type of payment. For example, the donation information 152 may indicate that the donation is to be paid off by a one-time withdrawal from a checking account, and the payment amount 162 may correspond to the amount of the one-time withdrawal from the checking account managed by the payment source 138. As another example, the donation information 152 may indicate that the donation is to be paid as a monthly payment of 1% of a saving's account balance, and the payment request 160 may be sent periodically (e.g., monthly) to the payment source 138 (or the payment source 138 may handle monthly sending of the payment amount 162). As another example, the donation information 152 may indicate that a 5% of all credit card payments for food over the next month are to be donated, and the payment request 160 may indicate that the platform 102 and/or the payment source 138 is to monitor transactions over the next month for food payments and to provide 5% of the identified transactions as the payment amount 162.

As yet another example, the donation information 152 may indicate that the donation is to be a recurring transaction-based amount. To illustrate, in some implementations, the payment source 138 may be a credit card account that is capable of monitoring each transaction, or enabling the platform 102 to monitor the transactions, and counting percentages or amounts based on the transactions. As a particular example, the donation information 152 may indicate that the donation is to be based on rounding up each transaction during a time period to the nearest full dollar amount. However, sending a payment request 160 each time there is a transaction may be inefficient and costly for the first user if there are fees associated with electronic transfers of money. Accordingly, in some implementations, the platform 102 may monitor transactions and maintain a count such that the payment requests 160 are transmitted only when the count satisfies (e.g., is greater than or equal to) a threshold. To illustrate, the payment manager 128 (e.g., the platform 102) may monitor the payment source 138 for one or more transactions during a time period and, for each of the one or more transactions, increment a payment count 129 corresponding to the second user by the recurring transaction-based amount. The payment manager 128 may initiate sending of the payment request 160 to the payment source 138 when the payment count 129 satisfies a threshold, and receiving the payment amount 162 may trigger the payment manager 128 to set the payment count 129 to zero (or another initial value). For example, with respect to rounding up each transaction to the nearest dollar, the payment manager 128 may monitor transactions of the payment source 138 and, for each transaction, compute the amount needed to round the value of the transaction to the nearest dollar. For each such transaction, the payment manager 128 may increment the payment count 129 by the computer value. For example, if a first transaction is for $19.95, a second transaction is for $341.23, and a third transaction is for $74.67, the payment manager 128 may increment the payment count 129 by 0.05, 0.77, 0.33, respectively. When the payment count 129 reaches a threshold, such as $2.00, $5.00, $10.00, or $20.00, as non-limiting examples, the platform 102 may send the payment request 160 (e.g., initiate an ACH payment) to the payment source 138 for the amount indicated by the payment count 129. This process may continue for the duration of the time period, or until a designated amount is reached. In this manner, the payment requests 160 are only sent infrequently, instead of responsive to each transaction, which may reduce network congestion caused by sending the payment requests 160 (and receiving the payment amounts 162) as well as reducing costs to the first user if there are fees associated with electronic fund transfers such as providing the payment amount 162 by the payment source 138.

The platform 102 may receive the payment amount 162 (e.g., an electronic fund transfer, an ACH payment, or any type of money or fund transfer) and provide the payment amount 162 to the account manager 122 for processing and management. For example, based on receiving the payment amount 162, the account manager 122 may increase (e.g., increment) an account value of a first account 124, such as a debit account or digital wallet, that corresponds to the second user by at least a portion of an amount of the payment amount 162. For example, if the payment amount 162 represents a donation of $20.00, the account manager 122 may increase the account value of the first account 124 from an initial value, such as zero or any initial value, to a final value, which in this example is $20.00 if the account manager 122 passes an entirety of the payment amount 162 to the second user. Once there is value in the first account 124, the account manager 122 may manage any transactions with respect to the first account 124, such as electronic fund transfers requested by the second user of the second user device 132, withdrawals requested by the second user, payments on behalf of the second user, or the like. Although a single account is shown in FIG. 1, the account manager 122 may be configured to set up and maintain an account for each individual (e.g., student athlete) that registers with the platform 102. Additionally or alternatively, the account manager 122 may set up and maintain payment accounts for donor users, which enables donors to deposit funds that can be used at any time to provide donations to individual members.

In some implementations, the account manager 122 may withhold or deduct some of the funds received by the platform 102 for the second user or stored in the first account 124 based on authorization by the second user of the second user device 132. One type of deduction performed by the account manager 122 may be to deduct fees for the business that runs the online marketplace. For example, the account manager 122 may deduct a percentage, such as 1-3%, of all received donations as fees. As another example, the account manager 122 may periodically collect fees from accounts of individuals, on a percentage or flat fee arrangement, or when users withdraw funds from their accounts. For example, the account manager 122 may deduct $5.00 a month from the first account 124 as fees, or the account manager 122 may deduct $2.00 for each withdrawal or transaction initiated with respect to the first account 124, as non-limiting examples. The fees may be explained during the registration process for the second user, and registration may be contingent on authorization of the platform 102 to deduct the fees according to the fee arrangement. Another type of deduction performed by the account manager 122 is the withholding of funds to comply with tax rules and regulations. As described above and also further herein with reference to FIG. 2, the registration process may include presenting the second user with a selectable option to withhold funds for tax purposes. If the user agrees to the withholding, the account manager 122 may deduct or withhold funds from the first account 124 based on the second user's authorization. The amount and time of the deductions may be specified by tax regulations or laws of a city, county, state, country, or other political region where the second user lives or where they are attending an educational institution. Responsive to selection to perform the tax withholding, the platform 102 may generate and maintain tax documents 116. The tax documents 116 may be completed based on user input from the second user of the second user device 132, and upon completion, the tax documents 116 may be sent to the second user device 132, an accountant, a tax agency, or a combination thereof. As a non-limiting example, the tax documents 116 may include a 1099 form used by the Internal Revenue Service (IRS) of the United States.

To enable the second user to access the funds stored in the first account 124, the account manager 122 (e.g., the platform 102) may initiate issuance of a debit card that is linked to the first account 124. Although described as a debit card, in other implementations the card may be a refillable stored value card (e.g., a gift card) or the like that stores a preprogrammed value set by a device that issues or reads the card. The issuance of the debit card may be initiated upon completion of the registration process by the second user, upon request by the second user, or at another time. In some implementations, the organization that maintains the platform 102 may also maintain automatic teller machines (ATMs) at which the debit card may be issued (or in the case of a stored value card, refilled), or the organization may have an agreement with other companies that offer ATMs to support issuance of debit cards and withdrawals using the debit cards (or in implementations that include stored value cards, refilling of the stored value cards). In some implementations using stored value cards, the stored value cards may be automatically refilled based on the account value of the corresponding account. For example, if the second user uses the stored value card to withdraw an entirety of the balance of the first account 124, when additional value is added to the first account 124, the second user may use the stored value card to withdraw more funds without taking any action on their part. In some other implementations, the stored value card may have stored the current account value of the first account 124 when inserted into an ATM (or when issued), and when withdrawals occur, the stored account value may be decreased until the value is zero. To refill the value stored on the stored value card, the second user may take some action, such as visiting a particular ATM that is communicatively coupled to the platform 102 or otherwise managed by the same organization, initiating updating of the stored value using a wireless connection (e.g., Wi-Fi, Bluetooth, etc.), or another action, to refill the value stored on the stored value card.

In some implementations, the account manager 122 may condition access to a debit card or to the value stored in accounts upon fulfilment of one or more criteria by the corresponding user. For example, the account manager 122 may condition issuance of a debit card, ability of the debit card to withdraw funds, ability of the second user to transfer money from the first account 124, or the like, upon the second user fulfilling one or more criteria. The criteria may involve goals advanced by the organization that supports the platform 102, completion of registration or authorization actions, other criteria, or a combination thereof. For example, the account manager 122 may restrict access to the first account 124 until the second user completes one or more financial literacy classes (e.g., online classes, in-person classes, etc.) and/or schedules a meeting with a financial advisor. As another example, the account manager 122 may restrict access to the first account 124 until the second user selects whether to initiate tax withholding. These examples are not limiting, and other examples of criteria for restricting access are possible. In other implementations, the account manager does not condition or restrict access to the first account 124 or the debit card based on any criteria.

Based on successful retrieval of the payment amount 162, and depositing at least a portion of the payment amount 162 in the first account 124, the platform 102 may generate a digital asset 166. For example, the digital asset generator 126 may generate the digital asset 166 based on an indication of successful retrieval of the payment amount 162 by the platform 102. The digital asset 166 may include or be based on a name of the second user of the second user device 132, an image of the second user, a likeness of the second user, or a combination thereof (e.g., the digital asset 166 may include or incorporate the NIL of the second user). In implementations in which there are rules or regulations regarding how the NILs of student athletes can be used, the digital asset 166 may be created in accordance with such rules or regulations. As a non-limiting example, the digital asset 166 may include or be based on an image of the second user of the second user device 132, such as a picture of the second user playing the sport for which they are a member of a team of an educational institution. In addition to including or being based on the NIL of the second user, the digital asset 166 may include an identification of ownership of the digital asset 166 by at least the first user of the first user device 130 (or by additional users if the digital asset 166 is generated based on a group donation). For example, the digital asset generator 126 may obtain digital content 112 that includes/is based on/incorporates the NIL of the second user of the second user device 132 and combine the digital content 112 with ownership information 114 to create the digital asset 166. The digital content 112 may include one or more images, one or more videos, one or more audio clips, a signature, manually-created art, digitally-created art, or the like, that includes or incorporates the NIL of the second user of the second user device 132 (and additional users if the donation for which the digital asset 166 is created is to multiple student athlete users). In some implementations, the digital asset generator 126 may perform web page or social media searches to obtain the digital content 112, request the digital content 112 from an educational institution or a sports team of an educational institution, or receive the digital content 112 from a third party service that is contracted to provide media data of student athletes or other individuals. Additionally or alternatively, the digital asset generator 126 may obtain the digital content 112 from individual members of the online marketplace, such as during a registration process or provided by the individual users during membership. The ownership information 114 may include or indicate a name of the first user of the first user device 130 (or multiple users if the donation is a group donation), a profile name of the first user, an address of the first user, other user-identifying information, as well as optionally a date or timestamp, an amount donated by the first user, other information, or a combination thereof. After generation of the digital asset 166 by the digital asset generator 126, the platform 102 may send the digital asset 166 to the first user device 130, and any other user devices for which users were involved in the donation, and/or the platform 102 may store the digital asset 166 at a location accessible by users of the online marketplace. Thus, sending the digital asset 166 may include sending data representing the digital asset 166 to the first user device 130, sending data representing a copy of the digital asset 166 to the first user device 130, providing access to a storage location of the digital asset 166 to the first user device 130, or a combination thereof. In some implementations, the platform 102 may provide a report with the digital asset 166 such that the donor user(s) are provided with information to confirm that their money was provided to the designated individual user(s), what fees were withheld, confirmation of the transaction for tax purposes, other information, or a combination thereof. Such reporting is optional and in other implementations is not included. Sending or providing the digital asset 166 in any of the above-described manners may complete the NIL transaction according to one or more NIL rules or regulations.

In some implementations, the digital asset 166 is a non-fungible token (NFT). In this context, an NFT is data stored in a blockchain (e.g., a form of distributed ledger) that records the ownership of a digital file and can be transferred or sold by the owner. To illustrate, the digital asset generator 126 may create digital assets by recording ownership data for digital content that includes or incorporates the NIL of individual users by adding entries to a blockchain. For example, the digital asset generator 126 may create the digital asset 166 by adding an entry to a blockchain that records the ownership information 114 (or a portion thereof) and that identifies the digital content 112 as being linked to the ownership information 114. The blockchain may be maintained by the platform 102 or distributed across multiple different devices for the purpose of identifying NFTs related to individuals such as student athletes. In some implementations, the blockchain may be configured such that only the platform 102 or other designated parties have the passwords or credentials necessary to add entries, thereby securing the blockchain from being added to by unwanted parties. Additionally, entries may be read without the credentials, allowing access by outside users to read the ownership of digital content provided by the entries of the blockchain. In implementations in which the digital assets created by the platform 102 are NFTs, sending the digital assets may include sending a copy of the identified digital content to the donor user, adding a new entry to the blockchain to link the digital content to ownership by the donor user, and providing access to the blockchain. For example, sending the digital asset 166 may include sending a copy of the digital content 112 to the first user device 130, adding an entry to the blockchain that links the digital content 112 to the ownership information 114, and providing access to the blockchain to the first user device 130. In some implementations, the platform 102 does not support transferring ownership of NFTs once they are created. In some other implementations, the platform 102 may allow users that own NFTs created by the platform 102 to transfer ownership to other users or other parties upon request, although the platform 102 may not verify such a transfer beyond requiring receipt of a request to transfer ownership from a particular user. For example, responsive to receiving a request from the first user of the first user device 130 to transfer ownership of the digital asset 166, the platform 102 may add a new entry to the blockchain that links the digital content 112 to different ownership information to transfer ownership of the digital asset 166.

In some implementations, instead of a donation by a single donor user, the donation may be a group donation. For example, the donation information 152 may indicate multiple donor users as the donors for the donation, and a corresponding payment source for each of the donor users, or one or more payment sources on behalf of all of the donor users. Alternatively, the first user of the first user device 130 may use their donation to set up a donor group. For example, the donation information 152 may include or be sent with a group request 154. The group request 154 may indicate that the donation indicated by the donation information 152 is to be combined with other donations as a group donation. For example, the group request 154 may identify one or more other donor users that are being requested to join the group donation, an amount that each user is requested to donate as members of the group donation, the recipient(s) of the group donation, a group name corresponding to the group donation, other information, or a combination thereof. Additional details of group donations are further described herein with reference to FIG. 3. Responsive to receiving the group request 154 (e.g., indicated by the donation information 152 or in a separate message), the platform 102 may send a group invitation 164 to the one or more other donor users indicated by the group request 154. As a particular example, if the group request 154 indicates that the third user of the third user device 134 is requested to join the group donation, the platform 102 may send the group invitation 164 to the third user device 134. In such an example, the group invitation 164 may indicate the requested donation amount, that the group donation was set up by the first user of the first user device 130, and the recipient of the group donation.

In some implementations, the platform 102 may maintain an online scoreboard of largest donors, largest donor groups, largest recipient groups, other users or groups, or a combination thereof. For example, the platform 102 may generate and maintain the scoreboard data 118 that indicates such users or groups. Providing the users with access to rankings of donors, of recipients, or the like, may provide donor users with incentive to donate to their favorite student athletes (e.g., individuals) to see their names listed in high scores. Additionally or alternatively, providing the users with the scoreboard may provide incentive for individual users to communicate to their fans that they are registered with the online marketplace for receiving donations, such as by providing their respective user indicia (e.g., the user indicia 158) in social media messages, advertisements, emails, and the like. In some implementations, the platform 102 may support other types of gamification in addition or in the alternative to the scoreboard represented by the scoreboard data 118. For example, the platform 102 may provide more desirable digital assets for larger donations, such as particular sizes or types of digital assets (e.g., signatures, images, videos, etc.) for different tiers of donation amounts. As another example, the platform 102 may provide chat or messaging services or message boards for users to communicate about their favorite sports, schools, or athletes, and the platform 102 may provide different customization features such as icons, avatars, titles, and the like, based on the amount of money donated by the donor users, based on the number of donations provided by the donor users, based on the amount of money received by the individual users, based on the number of donations received by the individual users, based on other user activity, or the like. As yet another example, the platform 102 may make donations to individual users of a donor user's choice based on the donor user donating particular amounts of money or making particular numbers of donations, based on the donor user or the individual user linking to social media messages or other online communications that include user indicia generated by the platform 102, based on other indications of promoting the online marketplace, or the like.

As described with reference to FIG. 1, the system 100 supports an online marketplace that facilitates the exchange of digital assets from individuals, such as student athletes, for donations (e.g., targeted payments) from donor users of the online marketplace. For example, the first user device 130 may send the donation information 152 that indicates a donation to an individual user to the platform 102, and the platform 102 may process the donation and provide at least a portion of the donation to the second user of the second user device 132 (e.g., an individual user designated as the recipient). The platform 102 may also generate and send the digital asset 166 to the first user device 130 based on successful retrieval of the payment amount 162 from the payment source 138 in order to complete the donation process in accordance with one or more NIL rules or regulations for student athletes. Thus, the system 100 may enable student athletes or other individuals to monetize their NIL in a safe and efficient manner that provides transparency and security to donors, thereby increasing the likelihood of donor users contributing funds to student athlete users or other individual users. As such, the system 100 leverages computer technology to involve fans in a new sports experience on an individual or small (e.g., micro) scale, compared to other NIL experiences that are predominately at larger commercial levels. In some implementations, the system 100 enables donors to donate to individuals in small amounts over time without significantly increasing network congestion or costs to the donor user. As an example, the donation information 152 may indicate that the donation is to be performed using transaction-based amounts, such as rounding up each transaction in a time period to the nearest dollar, and the payment manager 128 of the platform 102 increments the payment count 129 for each amount that is rounded up. When the payment count 129 satisfies a threshold, the platform 102 sends the payment request 160 to the payment source 138 to retrieve the payment amount 162. This process reduces network congestion as compared to sending a request for each transaction and avoids excess fees to the donor user by using only a small number of payment requests, each of which may be associated with a fee by the donor user's bank or credit card.

In some implementations, a system (e.g., 100) for providing an online marketplace that facilitates exchange of digital assets from student athletes for donations includes at least one memory (e.g. 106) storing instructions (e.g., 108) and one or more processors (e.g., 104) coupled to the at least one memory. The one or more processors are configured to execute the instructions to cause the one or more processors to receive donation information (e.g., 150) from a first user (e.g., 130) associated with an online marketplace platform. The donation information indicates a payment source (e.g., 138), a payment amount (e.g., 168), and a designation of a second user (e.g., 132) associated with the online marketplace platform as a recipient. The second user is a student athlete. Execution of the instructions also causes the one or more processors to retrieve the payment amount from the payment source. Execution of the instructions causes the one or more processors to increase an account value of an account (e.g., 124) corresponding to the second user by at least a portion of the payment amount. Execution of the instructions also causes the one or more processors to generate a digital asset (e.g., 166) that includes a name of the second user, an image of the second user, a likeness of the second user, or a combination thereof. Execution of the instructions further causes the one or more processors to send the digital asset to the first user based on retrieval of the payment amount.

Referring to FIG. 2, an example of a GUI that displays profile information for a user of the online marketplace of FIG. 1 according to one or more aspects is shown as a GUI 200. In some implementations, the platform 102 of FIG. 1 may cause display of the GUI 200 at the second user device 132 (e.g., a user device of an individual user). For example, the GUI 200 may be a student athlete user profile GUI that provides a viewer with information and configurable settings corresponding to a particular student athlete user of the online marketplace. In other examples, the GUI 200 may be a GUI of a different type of individual user.

In the example shown in FIG. 2, the GUI 200 includes an account balance 202, donation details 210, registration information 220, NFT settings 230, and reminders 240. In some other implementations, the GUI 200 may be differently arranged, one or more of the information 202-240 may be optional or not included, other information may be included, or a combination thereof. The account balance 202 represents an amount of money (e.g., a balance) currently stored in an account linked to the user profile (“State Lineman 34”). For example, the account balance 202 may include or correspond to the balance of the first account 124 of FIG. 1. The donation details 210 may include information about one or more donations that have been received on behalf of the particular student athlete user. For example, the donation details 210 may include a number of donations received by the particular student athlete user, the average donation amount received by the particular student athlete user, a donor user who provided the largest donation to the particular student athlete user, a ranking (e.g., based on total donation amount, number of donations, or the like) of the particular student athlete user against other student athlete users registered with the same educational institution, a ranking of the particular student athlete user against other student athlete users registered as playing the same sport, and a ranking of the particular student athlete user against all other student athlete users of the online marketplace. Such information is illustrative, and in other implementations, the donation details 210 may include more information, less information, or different information than shown in FIG. 2.

The registration information 220 may include identifying information of the particular student athlete user that may be input during a registration process for the particular student athlete user. In the example shown in FIG. 2, the identifying information includes a name (“Steve Footballer”), a school (“Anyplace State University”), a sport (“football”), a position (“offensive line”), and a class (“sophomore”). In other implementations, the registration information 220 may include more information, less information, or different information. In some implementations, one or more pieces of the registration information 220 may be verified (e.g., by the platform 102 of FIG. 1 or a third party identification service). For example, an illustrative school field 222 may be displayed with a corresponding indicator 224 that shows whether the information of the school field 222 is verified. To illustrate, the indicator 224 may have a first value (e.g., a checkmark or another value) if the information in the corresponding field is verified, and a second value (e.g., an x or another value, or the indicator 224 may be left blank) if the information in the corresponding field is not verified. Additionally or alternatively, the registration information 220 may include a link 226 to terms and conditions (TOCs), registration documents, authorizations, or a combination thereof, that were agreed and authorized or signed by the particular student athlete user during the registration process. For example, the link 226 may like to a document that includes authorization by the particular student athlete user for money to be received and held on their behalf and for digital assets, such as NFTs, to be created and provided to donors on behalf of the particular student athlete user. Additional authorization documents may include authorization to deduct fees from donations, authorization to withhold for tax purposes, authorization to share information with the public, indemnification authorizations, and the like.

The NFT settings 230 may include configurable settings associated with generating NFTs (or other digital assets) on behalf of the particular student athlete user. For example, the NFT settings 230 may include an upload option 232 and an affiliates option 234. The upload option 232 may enable the particular student athlete user to submit digital content, such as image(s), video(s), audio clip(s), signature(s), or the like, for use in creating NFTs. In some implementations, the uploaded digital content may be specified for use in creating NFTs for particular users, particular donor tiers, particular donor groups, other configurations, or the like. The affiliates option 234 may enable the particular student athlete user to authorize the obtaining of digital content from third parties (e.g., affiliates) for use in generating NFTs. For example, the affiliates option 234 may include a button, a checkbox, or another type of selectable option that, when selected, authorizes the platform 102 of FIG. 1 to obtain digital content from third party sources (e.g., affiliates) that provide sports-related digital content.

The reminders 240 include one or more reminders of actions to be performed by the student athlete user. For example, the reminders 240 may include a first reminder 242 to complete a financial literacy course, a second reminder 244 to attend a scheduled meeting with a financial advisor, and a third reminder 246 to select a tax withholding option. The third reminder 246 may include a selectable option that authorizes the platform 102 of FIG. 1 to withhold a portion of donations received on behalf of the particular student athlete for tax purposes. The tax withholding procedures may be further described in the documents available via the link 226. If the particular student athlete user selects to authorize withholding for tax purposes, the tax documents 116 of FIG. 1 may be generated and provided or made accessible to the particular student athlete user. The options shown in FIG. 2 are illustrative and in other examples, the reminders 240 may include different reminders, such as reminders to provide digital content, to schedule a meeting with a financial advisor, or the like. In some implementations, the particular student athlete user may be required to perform the actions indicated by the reminders 240 in order to access the money indicated by the account balance 202. In some other implementations, the reminders 240 may be provided for the benefit of the particular student athlete user without being used as criteria for access to the money indicated by the account balance 202. Additionally or alternatively, the reminders 240 may include a reminder to share the particular student athlete user's user indicia 248 and/or user profile name. For example, by sharing the user indicia 248 and/or the profile name in social media messages, emails, message board posts, or other communications, the particular student athlete user can provide a quick and easy means for their fans to donate to them via the online marketplace. In the example shown in FIG. 2, the user indicia 248 is a QR code. In other implementations, the user indicia 248 may be a bar code, a hash, a profile name, a handle, or some other uniquely identifying information that also optionally links a viewer's browser to the online market place and to the user profile of the particular student athlete user.

Referring to FIG. 3, an example of a GUI that displays donation information for donating to individual(s) using the online marketplace of FIG. 1 according to one or more aspects is shown as a GUI 300. The individual(s) may be student athlete(s) or any other type of individual user. In some implementations, the platform 102 of FIG. 1 may cause display of the GUI 300 at the first user device 130 (e.g., a user device of a donor user). For example, the GUI 300 may be a donation setup GUI that provides a viewer with information and configurable settings for making a donation via the online marketplace. In the example shown in FIG. 3, the GUI 300 includes donation information 302, recipient information 320, group donation information 330, and a submit button 340. In some other implementations, the GUI 300 may be differently arranged, one or more of the information 302-330 may be optional or not included, other information may be included, or a combination thereof. The submit button 340 enables submission of the donation once any and all configurations and information are provided in the GUI 300.

The donation information 302 may include a user identifier 304, payment source options 306, and payment options 310. The user identifier 304 may include a profile name (“State_Superfan_LB1”) of the donor user that is creating the donation. The payment source options 306 include one or more selectable options for designating a payment source for the donation. In some implementations, the payment source options 306 correspond to one or more payment sources that are linked to the donor user's account. The donor user may select which payment source to use for the donation by selecting the corresponding selectable option. For example, an illustrative selectable option 308 may include a button, a checkbox, or the like, that allows selection of the corresponding payment source (“Premiere Credit Card #4572065”). In addition to one or more options corresponding to payment sources linked to the donor user's profile, the payment source options 306 may include an add new payment source option.

The payment options 310 may include one or more selectable options for designating an amount and type of payment for the donation. In some implementations, the platform 102 may be configured to support multiple types of donations shown as the payment options 310 in FIG. 3, including a one-time donation, a percentage of a balance donation, a percentage of a transaction donation, a recurring transaction-based donation, or another type of donation. A one-time donation may be a donation of a particular value for a single time. A percentage of balance donation includes a donation based on a particular portion (e.g., a percentage) of a balance of a corresponding payment source. A percentage of transaction donation includes a donation based on a particular portion (e.g., a percentage) of one or more transactions, such as transactions during a designated time period. A recurring transaction-based donation includes a donation of a particular amount based on one or more transactions during a designated time period, such as rounding up each transaction to the nearest dollar and using the amount that is rounded up as the donation. The examples shown in FIG. 3 are illustrative, and in other implementations the payment options 310 may include fewer options, more options, or different options than shown in FIG. 3. Each option may be associated with one or more selected options for configuring the payment. For example, the recurring transaction-based donation is associated with a selectable option 312, such as a button, a checkbox, or the like, that enables selection of this type of donation, in addition to an amount selector 314 that enables selection of the amount for the transaction-based donation. In the example shown in FIG. 3, the donor user has selected to round up transactions to the nearest dollar and use the roundup amounts as donations.

The recipient information 320 includes one or more selectable options for designating the recipient(s) of the donation. For example, the recipient information may include selectable options for a single recipient and a recipient group (e.g., multiple recipients). To further illustrate, an illustrative selectable option 322, such as a button, a checkbox, or the like, enables the donor user to select the type of recipient (e.g., single or group) for the donation. In the example shown in FIG. 3, the donor user has selected to designate a recipient group to receive the donation. Upon selecting the recipient group option, multiple recipients may be added, and as the recipients are added, the users are displayed in the GUI 300. For example, the GUI 300 displays recipient users 324 that are designated by the donor user. To support adding of recipients, the recipient information 320 may include an option 326 to add a user by name and an option 328 to add users by category. The option 326 may enable the donor user to enter a user name or to select a user name from a list, such as an alphabetized list, for adding to the recipient users 324. The options 328 may enable the donor user to search for individual users by categories by selecting a category option 329. For example, the donor user may be able to select a search category of school, sport, position, class, or the like, using the category option 329, and the corresponding list may be displayed or the corresponding group may be added to the recipient users 324.

The group donation information 330 may include one or more selectable options and configurations for setting up a group donation. For example, the group donation information 330 may include a selectable option 332, such as a button, a checkmark, or the like, that enables the donor user to make this donation a group donation. The group information may also include a group name field 334 that enables the donor user to enter a group name to be associated with the group donation. Upon selecting selectable option 332, multiple requested donor users may be added, and as the donor users are added, the users are displayed in the GUI 300. For example, the group donation information 330 may include donor users 336 that are requested to join the group donation by the donor user. To support adding of donor users, the group donation information 330 may include an option 338 to add a user by name that enables the donor user to enter a user name or to select a user name from a list, such as an alphabetized list, for adding to the donor users 336. Upon submission of the donation, the group invitation 164 of FIG. 1 may be sent to each of the donor users 336 identified in the GUI 300.

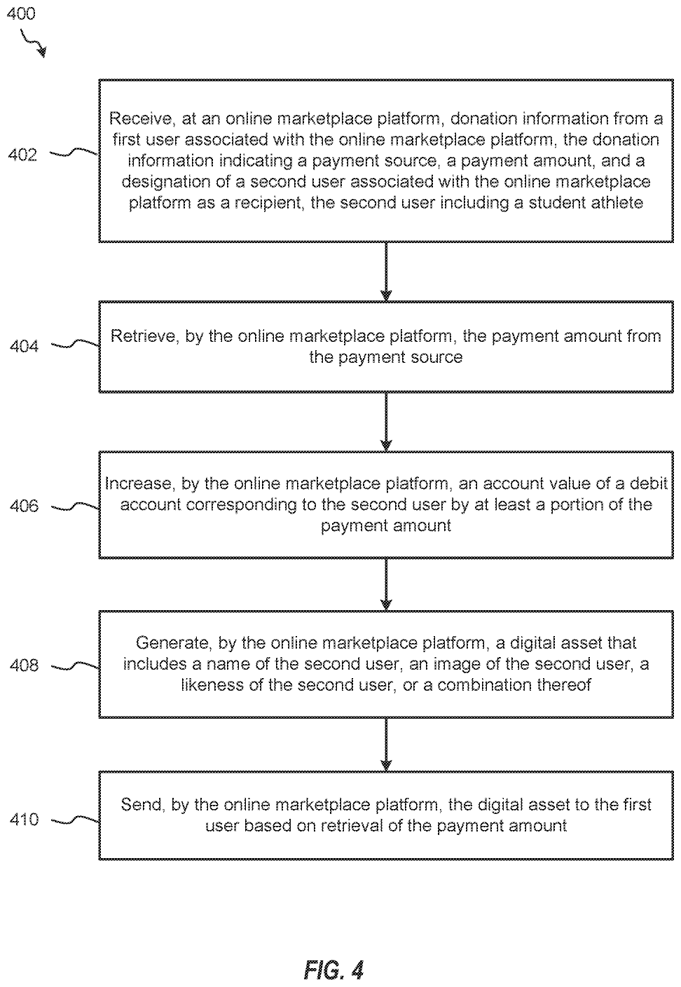

Referring to FIG. 4, a flow diagram of a method for providing an online marketplace that facilitates exchange of digital assets from student athletes for donations according to one or more aspects is shown as a method 400. In some implementations, method 400 may be performed by an online marketplace platform, such as the platform 102 of FIG. 1 (e.g., a computing device configured to support an online marketplace for exchanging donations for digital assets of student athletes). Alternatively, the online marketplace platform may support exchange of donations for digital assets of other types of individual users. In some implementations, the method 400 may be stored in a computer-readable storage medium as instructions that, when executed by one or more processors, cause the one or more processors to perform the operations of the method 400.

At 402, the method 400 includes receiving donation information from a first user associated with the online marketplace platform. The donation information indicates a payment source, a payment amount, and a designation of a second user associated with the online marketplace platform as a recipient. The second user includes a student athlete. For example, the donation information may include or correspond to the donation information 152 of FIG. 1, the payment amount includes or corresponds to the payment amount 162 of FIG. 1, the first user includes or corresponds to a user of the first user device 130 of FIG. 1, and the second user includes or corresponds to a student athlete user of the second user device 132 of FIG. 1. At 404, the method 400 includes retrieving the payment amount from the payment source. For example, the payment amount may include or correspond to the payment amount 162 of FIG. 1.

At 406, the method 400 includes increasing an account value of an account corresponding to the second user by at least a portion of the payment amount. For example, the account may include or correspond to the first account 124 of FIG. 1. At 408, the method 400 includes generating a digital asset that includes a name of the second user, an image of the second user, a likeness of the second user, or a combination thereof. For example, the digital asset may include or correspond to the digital asset 166 of FIG. 1. At 410, the method 400 includes sending the digital asset to the first user based on retrieval of the payment amount. For example, the digital asset 166 of FIG. 1 may be sent to the first user device 130 based on retrieval of the payment amount 162 from the payment source 138.

In some implementations, the digital asset includes an NFT, and generating the digital asset includes obtaining digital content that includes the name of the second user, the image of the second user, the likeness of the second user, or a combination thereof, and adding an entry to a blockchain. The entry includes the digital content and indicates ownership of the digital content by the first user. For example, the digital content may include or correspond to the digital content 112 of FIG. 1, and the ownership may be indicated by the ownership information 114 of FIG. 1 which may be included in a blockchain entry with the digital content 112. In some such implementations, sending the digital asset to the first user includes sending a copy of the digital asset to the first user, providing access to the blockchain to the first user, or both, as further described above with reference to FIG. 1.

In some implementations, the payment amount includes a recurring transaction-based amount, and retrieving the payment amount includes monitoring the payment source for one or more transactions, for each of the one or more transactions, incrementing a payment count by the recurring transaction-based amount, and sending a payment request to the payment source based on the payment count satisfying a threshold. For example, the payment count may include or correspond to the payment count 129 of FIG. 1. In some such implementations, the payment request is configured to initiate an ACH payment by the payment source. For example, the payment request may include or correspond to the payment request 160 of FIG. 1, which may initiate an ACH payment by the payment source 138.

In some implementations, the method 400 further includes initiating issuance of a debit card that is linked to the account based on successful registration of the second user. For example, the account manager 122 of FIG. 1 may be configured to initiate issuance of a debit card that is linked to the first account 124. In some such implementations, the issuance of the debit card is conditioned upon the second user fulfilling one or more criteria. The one or more criteria include completing one or more financial literacy classes, selecting whether to initiate tax withholding, scheduling a meeting with a financial advisor, or a combination thereof, as further described above with reference to FIGS. 1-2.

In some implementations, the method 400 also includes registering the second user. The registering includes verifying an identity of the second user, verifying an enrollment of the second user with one or more educational institutions (e.g., via a college issued email address, a sports team roster, or the like), and receiving user authorization to receive donations on behalf of the second user and to provide the digital asset on behalf of the second user, as further described above with reference to FIGS. 1-2. In some such implementations, the registering also includes initiating presentation of a selectable option to initiate tax withholding for funds deposited in the account and, based on selection of the selectable option, providing one or more electronic tax documents to the second user. For example, the selectable option may include or correspond to the selectable option of the third reminder 246 of FIG. 2.

In some implementations, the donation information also includes a request to create a donor group that includes at least a third user associated with the online marketplace platform. For example, the request may include or correspond to the group request 154 of FIG. 1, and the third user may include or correspond to a user of the third user device 134 of FIG. 1. In some such implementations, the method 400 further includes sending an invitation to join the donor group to the third user. The invitation identifies the first user, the payment amount, and the designation of the second user as the recipient. For example, the invitation may include or correspond to the group invitation 164 of FIG. 1.

In some implementations, the payment source includes a credit card account or a bank account, and the payment amount includes a particular amount, a percentage of a balance, a percentage of a particular transaction, or a recurring transaction-based amount. Additionally or alternatively, the online marketplace platform may receive the donation information from a first user device executing an online marketplace application and may send the account value of the account to a second device executing the online marketplace application. For example, the first user device may include or correspond to the first user device 130 of FIG. 1 and the second user device may include or correspond to the second user device 132 of FIG. 1.

In some implementations, the designation of the second user as the recipient includes a designation of a user group that includes the second user. The user group corresponds to a team for a particular sport at a particular educational institution. For example, the donation information 152 of FIG. 1 may indicate a user group as the designation. Additionally or alternatively, the designation of the second user as the recipient may include a designation of a user group that includes the second user. The user group includes a custom grouping of student athletes selected by the first user. For example, the donation information 152 of FIG. 1 may indicate a custom grouping of student athlete users. In either of these examples, the user group may include a user of the second user device 132 of FIG. 1 and a user of the fourth user device 136 of FIG. 1.

In some implementations, the method 400 also includes generating a user indicia corresponding to the second user. The user indicia is configured to include an account identifier associated with the second user. For example, the user indicia may include or correspond to the user indicia 248 of FIG. 2. In some such implementations, the user indicia includes a bar code or a QR code. Additionally or alternatively, the method 400 may further include maintaining an online scoreboard of largest donors, largest donor groups, largest recipients, largest recipient groups, or a combination thereof. For example, the online scoreboard may include or correspond to the scoreboard data 118 of FIG. 1.

In some implementations, methods can be combined with other operations described herein, for example, one or more operations of the method 400 of FIG. 4 may be combined with one or more operations of other methods described herein, or one or more of the operations of the method 400 may be performed in a different order. Additionally or alternatively, one or more operations described with reference to one of the method 400 of FIG. 4 may be combined with one or more operations described with reference to FIGS. 1-3.

Although one or more of the disclosed figures may illustrate systems, apparatuses, methods, or a combination thereof, according to the teachings of the disclosure, the disclosure is not limited to these illustrated systems, apparatuses, methods, or a combination thereof. One or more functions or components of any of the disclosed figures as illustrated or described herein may be combined with one or more other portions of another function or component of the disclosed figures. Accordingly, no single implementation described herein should be construed as limiting and implementations of the disclosure may be suitably combined without departing from the teachings of the disclosure.

The steps of a method or algorithm described in connection with the implementations disclosed herein may be included directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

Although the present disclosure and its advantages have been described in detail, it should be understood that various changes, substitutions and alterations can be made herein without departing from the scope of the present disclosure as defined by the appended claims. Moreover, the scope of the present application is not intended to be limited to the particular aspects of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or steps.

What is claimed is:

1. A method for providing an online marketplace that facilitates exchange of digital assets from student athletes for donations, the method comprising:
receiving, at an online marketplace platform, donation information from a first user associated with the online marketplace platform, the donation information indicating a payment source, a payment amount, and a designation of a second user associated with the online marketplace platform as a recipient, the second user comprising a student athlete;
retrieving, by the online marketplace platform, the payment amount from the payment source;
increasing, by the online marketplace platform, an account value of an account corresponding to the second user by at least a portion of the payment amount;
generating, by the online marketplace platform, a digital asset that includes a name of the second user, an image of the second user, a likeness of the second user, or a combination thereof; and
sending, by the online marketplace platform, the digital asset to the first user based on retrieval of the payment amount.

2. The method of claim 1, where the digital asset comprises a non-fungible token (NFT), and where generating the digital asset comprises:
obtaining digital content that includes the name of the second user, the image of the second user, the likeness of the second user, or a combination thereof; and
adding an entry to a blockchain, the entry identifying the digital content and indicating ownership of the digital content by the first user.

3. The method of claim 2, where sending the digital asset to the first user comprises sending a copy of the digital asset to the first user, providing access to the blockchain to the first user, or both.

4. The method of claim 1, where the payment amount comprises a recurring transaction-based amount, and where retrieving the payment amount comprises:
monitoring the payment source for one or more transactions;
for each of the one or more transactions, incrementing a payment count by the recurring transaction-based amount; and
sending a payment request to the payment source based on the payment count satisfying a threshold.

5. The method of claim 4, where the payment request is configured to initiate an Automated Clearing House (ACH) payment by the payment source.

6. The method of claim 1, further comprising:
initiating, by the online marketplace platform, issuance of a debit card that is linked to the account based on successful registration of the second user.

7. The method of claim 6, where the issuance of the debit card or access to funds in the account is conditioned upon the second user fulfilling one or more criteria, the one or more criteria comprising completing one or more financial literacy classes, selecting whether to initiate tax withholding, scheduling a meeting with a financial advisor, or a combination thereof.

8. The method of claim 1, further comprising registering, by the online marketplace platform, the second user, where the registering comprises:
verifying an identity of the second user;
verifying an enrollment of the second user with one or more educational institutions; and
receiving user authorization to receive donations on behalf of the second user and to provide the digital asset on behalf of the second user.

9. The method of claim 8, where the registering further comprises:
initiating presentation of a selectable option to initiate tax withholding for funds deposited in the account; and
based on selection of the selectable option, providing one or more electronic tax documents to the second user.

10. The method of claim 1, where the donation information includes a request to create a donor group that includes at least a third user associated with the online marketplace platform.

11. The method of claim 10, further comprising:
sending, by the online marketplace platform, an invitation to join the donor group to the third user, the invitation identifying the first user, the payment amount, and the designation of the second user as the recipient.

12. A system for providing an online marketplace that facilitates exchange of digital assets from student athletes for donations, the system comprising:
at least one memory storing instructions; and
one or more processors coupled to the at least one memory, the one or more processors configured to execute the instructions to cause the one or more processors to:
receive donation information from a first user associated with an online marketplace platform, the donation information indicating a payment source, a payment amount, and a designation of a second user associated with the online marketplace platform as a recipient, the second user comprising a student athlete;
retrieve the payment amount from the payment source;
increase an account value of an account corresponding to the second user by at least a portion of the payment amount;
generate a digital asset that includes a name of the second user, an image of the second user, a likeness of the second user, or a combination thereof; and
send the digital asset to the first user based on retrieval of the payment amount.

13. The system of claim 12, where the payment source comprises a credit card account or a bank account, and where the payment amount comprises a particular amount, a percentage of a balance, a percentage of a particular transaction, or a recurring transaction-based amount.

14. The system of claim 12, where the one or more processors are configured to receive the donation information from a first user device executing an online marketplace application, and where the one or more processors are further configured to send the account value of the account to a second device executing the online marketplace application.

15. The system of claim 12, where the designation of the second user as the recipient comprises a designation of a user group that includes the second user, the user group corresponding to a team for a particular sport at a particular educational institution.

16. The system of claim 12, where the designation of the second user as the recipient comprises a designation of a user group that includes the second user, the user group comprising a custom grouping of student athletes selected by the first user.

17. A computer-readable storage device storing instructions that, when executed by one or more processors, cause the one or more processors to perform operations for providing an online marketplace that facilitates exchange of digital assets from student athletes for donations, the operations comprising:
receiving donation information from a first user associated with an online marketplace platform, the donation information indicating a payment source, a payment amount, and a designation of a second user associated with the online marketplace platform as a recipient, the second user comprising a student athlete;
retrieving the payment amount from the payment source;
increasing an account value of an account corresponding to the second user by at least a portion of the payment amount;
generating a digital asset that includes a name of the second user, an image of the second user, a likeness of the second user, or a combination thereof; and
sending the digital asset to the first user based on retrieval of the payment amount.

18. The computer-readable storage device of claim 17, where the operations further comprise:
generating a user indicia corresponding to the second user, the user indicia configured to include an account identifier associated with the second user.

19. The computer-readable storage device of claim 18, where the user indicia comprises a bar code or a QR code.

20. The computer-readable storage device of claim 17, where the operations further comprise:
maintaining an online scoreboard of largest donors, largest donor groups, largest recipients, largest recipient groups, or a combination thereof.
